(19) United States
(12) Patent Application Publication
(10) Pub. No.: US 2022/0177053 A1
(43) Pub. Date: Jun. 9, 2022

(54) CARGO BED RAIL

(71) Applicant: CANADIAN TIRE CORPORATION LIMITED, Toronto (CA)

(72) Inventors: David GREEN, Toronto (CA); John Paul SCHMIDER, Scarborough (CA); Abdul Haleem Ahamed KOYA, Oakville (CA); Chris HECK, Barrie (CA); Michael Joseph PAINTER, Johnstown, OH (US); Donald Collins MEVES, Gahanna, OH (US); Christopher Scott DANIELS, Columbus, OH (US)

(21) Appl. No.: 17/542,847

(22) Filed: Dec. 6, 2021

Related U.S. Application Data
(60) Provisional application No. 63/121,692, filed on Dec. 4, 2020.

(51) Int. Cl. B62D 33/02

(52) U.S. Cl. CPC B62D 33/0207

(57) ABSTRACT

A cargo bed system includes a rail for mounting to a vehicle having a cargo bed. The rail includes a lower extension having a first side and a second side, opposite the first side, extending along a length; an upper extension extending generally perpendicularly from the length of the lower extension, supportable by the vehicle; a clamp track located on the first side of the lower extension and extending along the length of the lower extension for receiving one or more clamps to secure the rail to the vehicle; and a lower accessory track located on the second side of the lower extension and extending along the length of the lower extension for receiving an accessory within the cargo bed.

### CROSS-REFERENCE TO RELATED APPLICATIONS

The present application claims the benefit of U.S. Provisional Patent Application No. 63/121,692 filed on Dec. 4, 2020, the contents of which are hereby incorporated by reference.

### FIELD

This disclosure relates to vehicle accessories, in particular, attachment and storage of vehicle accessories in a vehicle cargo bed.

### BACKGROUND

Vehicles such as pick-up trucks typically have an enclosed cab and an open cargo area defined by a cargo body, such as a cargo bed or truck bed, in the rear of the vehicle.

To utilize the cargo area, existing mechanisms provide tie-down or attachment points located along interior walls or on a bracket or rail mounted to the cargo bed to which objects can be secured. Such objects can include vehicle accessories such as a tonneau cover, a storage box, a cargo rack or a headache rack.

However, traditional rails provide only limited number of attachment points and configurations to secure an accessory and thus can accommodate the simultaneous use of only a limited number of accessories.

Furthermore, traditional rails may not be able to accommodate variance in vehicles and cargo beds, as there may be limited access points available for a rail to be mounted to the cargo bed.

### SUMMARY

According to an aspect, there is provided a rail for mounting to a vehicle having a cargo bed, the rail comprising: a lower extension having a first side and a second side, opposite the first side, extending along a length; an upper extension extending generally perpendicularly from the length of the lower extension, supportable by the vehicle; a clamp track located on the first side of the lower extension and extending along the length of the lower extension for receiving one or more clamps to secure the rail to the vehicle; and a lower accessory track located on the second side of the lower extension and extending along the length of the lower extension for receiving an accessory within the cargo bed.

In some embodiments, the one or more clamps are shaped to slidably engage with the clamp track.

In some embodiments, the clamp track defines a recess within the lower extension.

In some embodiments, the clamp track includes a protrusion from the lower extension.

In some embodiments, the clamp track is continuous along the length of the lower extension.

In some embodiments, the accessory is shaped to slidably engage with the lower accessory track.

In some embodiments, the lower accessory track defines a recess within the lower extension.

In some embodiments, the lower accessory track includes a protrusion from the lower extension.

In some embodiments, the lower accessory track is continuous along the length of the lower extension.

In some embodiments, the upper extension includes an upper accessory track extending along a length of the upper extension for receiving an additional accessory above the cargo bed.

In some embodiments, the upper accessory is shaped to slidably engage with the upper accessory track.

In some embodiments, the upper accessory track defines a recess within the upper extension.

In some embodiments, the upper accessory track includes a protrusion from the upper extension.

In some embodiments, the upper extension has a first side adjacent the vehicle and a second side, opposite the first side of the upper extension, the second side of the upper extension including a generally flat surface to support a tonneau cover.

In some embodiments, the rail further comprises an additional lower accessory track located on the second side of the lower extension and extending along the length of the lower extension for receiving an accessory within the cargo bed.

According to another aspect, there is provided a system for use with a cargo bed of a vehicle, comprising: a plurality of clamps; and two rails mountable to the vehicle, adjacent opposing sides of the cargo bed, each rail of the two rails including: a lower extension having a first side and a second side, opposite the first side, extending along a length; an upper extension extending generally perpendicularly from the length of the lower extension, supportable by the vehicle; a clamp track located on the first side of the lower extension and extending along the length of the lower extension for receiving one or more of the plurality of clamps; and a lower accessory track located on the second side of the lower extension and extending along the length of the lower extension for receiving an accessory within the cargo bed, wherein the plurality of clamps are shaped to engage with the clamp track of each rail to secure that rail to the vehicle.

In some embodiments, the plurality of clamps are shaped to slidably engage with the clamp track of each rail.

In some embodiments, the plurality of clamps are configured to apply a clamping force to the vehicle retained by a balancing force of the upper extension.

In some embodiments, each of the plurality of clamps includes a guide to engage with the clamp track and a movable arm adjustable in length to contact the vehicle.

In some embodiments, the accessory is shaped to slidably engage with the lower accessory tracks of the two rails.

In some embodiments, the accessory is a storage box.

In some embodiments, the upper extension of each rail includes an upper accessory track extending along a length of the upper extension for receiving an additional accessory above the cargo bed.

In some embodiments, the additional accessory is shaped to slidably engage with the upper accessory tracks of the two rails.

In some embodiments, the additional accessory is a rack.

In some embodiments, the upper extension of each rail has a first side adjacent the vehicle and a second side, opposite the first side of the upper extension, the second side of the upper extension including a generally flat surface to support a tonneau cover.

According to a further aspect, there is provided a method for installing a cargo bed system including a clamp and a rail on a vehicle, the rail including a lower extension having a first side and a second side, opposite the first side, extending along a length, and the rail further including an upper extension extending generally perpendicularly from the length of the lower extension, the method comprising: positioning the rail on the vehicle for the vehicle to support the upper extension; engaging the clamp with a clamp track on the first side of the lower extension; selectively positioning the clamp in the clamp track along the length of the lower extension; tightening the clamp to apply a clamping force to the vehicle to retain the rail against the vehicle; and retaining an accessory in a lower accessory track on the second side of the lower extension.

In some embodiments, the engaging the clamp with the clamp track comprises slidably engaging the clamp with the clamp track.

In some embodiments, the tightening the clamp comprises rotating the clamp to extend a movable arm of the clamp to contact the vehicle.

In some embodiments, the retaining the accessory comprises slidably engaging the accessory with the lower accessory track.

In some embodiments, the method further comprises retaining an additional accessory in an upper accessory track of the upper extension, the upper accessory track extending along a length of the upper extension.

In some embodiments, the method further comprises positioning a tonneau cover to contact a generally flat surface of the upper extension, the generally flat surface opposite a side of the upper extension adjacent the vehicle.

Other features will become apparent from the drawings in conjunction with the following description.

### BRIEF DESCRIPTION OF DRAWINGS

In the figures which illustrate example embodiments,

FIG. 1 is a perspective view of a cargo bed system including a cargo bed rail and a rack mounted on a vehicle, in accordance with an embodiment;

FIG. 2 is an exploded perspective view of a cargo bed rail and part of a rack, in accordance with an embodiment;

FIG. 3 is a partial cross-section view of a cargo bed rail mounted on a vehicle taken along lines I-I of FIG. 1, according to an embodiment;

FIGS. 4A-4F illustrate partial cross-section views of various embodiments of a cargo bed rail mounted on a vehicle, taken along lines I-I of FIG. 1;

FIG. 5A is a perspective view of a spring clamp for a tonneau cover, according to an embodiment;

FIG. 5B is a perspective view of a spring clamp on a tonneau cover, in use on a vehicle, according to an embodiment;

FIG. 6 is a perspective view of a cargo bed system including another rack mounted on a vehicle, in accordance with an embodiment; and

FIG. 7 is a flow chart of a method for installing a cargo bed system, according to an embodiment.

### DETAILED DESCRIPTION

Cargo bed systems and methods disclosed herein can, in some embodiments, allow for multiple accessories to be attached in multiple and different configurations in and adjacent to a cargo bed of a vehicle.

In some embodiments, rails are included that are attachable to a vehicle with a track for receiving clamps to mount the rails to the vehicle and including multiple tracks that can receive accessories. Conveniently, multiple vehicle accessories can be incorporated on a vehicle simultaneously, such as a tonneau cover, storage box, cargo rack, and headache rack, such that all accessories can be used at the same time, thus allowing for improved hauling, securing and organization of items in a cargo bed of a vehicle.

Aspects of various embodiments are described through reference to the drawings.

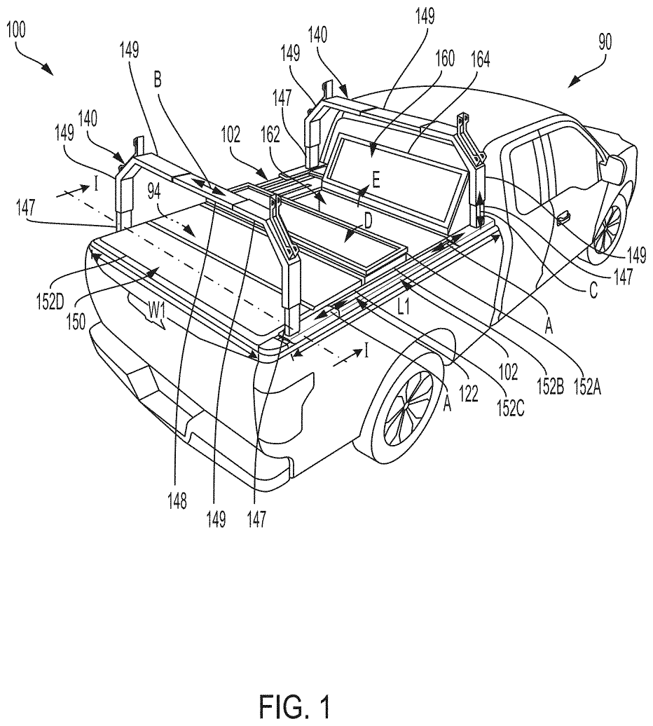

FIG. 1 illustrates an embodiment of a cargo bed system 100 for mounting adjacent to a cargo bed 94, in an example, a shoulder or sidewall 92 of a vehicle 90 such as a truck, as shown.

Vehicle 90 can include a cargo bed 94 having a length L1 and a width W1, and bordered by sidewall 92, which can include a bed rail or a bed rail cap.

One or more rails 102 of cargo bed system 100 can receive accessories such as one or more racks 140, a tonneau cover 150 or a storage box 160, in various configurations in or adjacent cargo bed 94. As shown in FIG. 1, rails 102 may be mounted on each side of width W1 of cargo bed 94 and extend along length L1 of cargo bed 94.

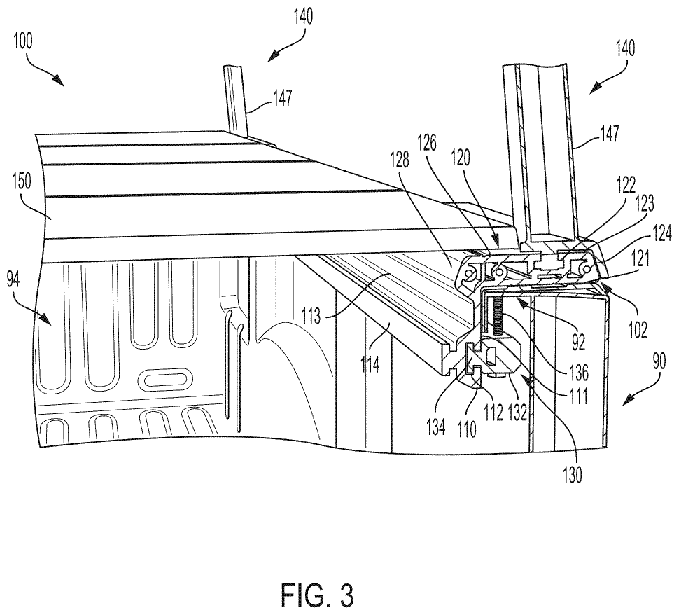

With reference by way of example to FIG. 1, rails 102 of cargo bed system 100 are attachable for installation in vehicle 90, for example, by way of one or more clamps 130 as illustrated in FIG. 3, to each sidewall 92 of vehicle 90, adjacent cargo bed 94. In use, rail 102 may extend generally parallel to length L1 of cargo bed 94, along all or part of length L1 of cargo bed 94.

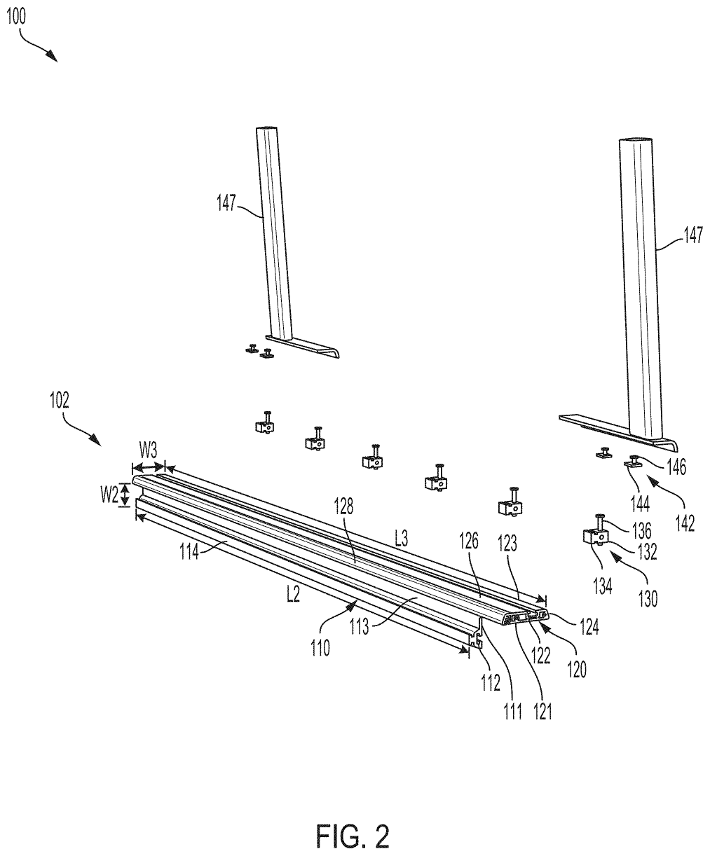

FIG. 2 illustrates an embodiment of rail 102 in further detail. In some embodiments, rail 102 is securable to a shoulder of cargo bed 94 with guides 134 of clamps 130 that are received in a clamp track 112 on a lower extension 110 of rail 102.

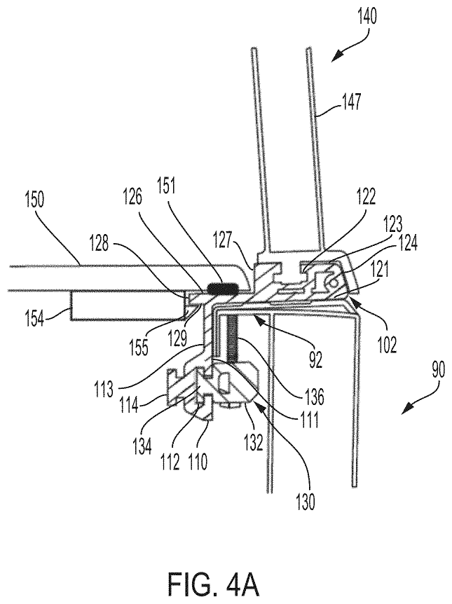

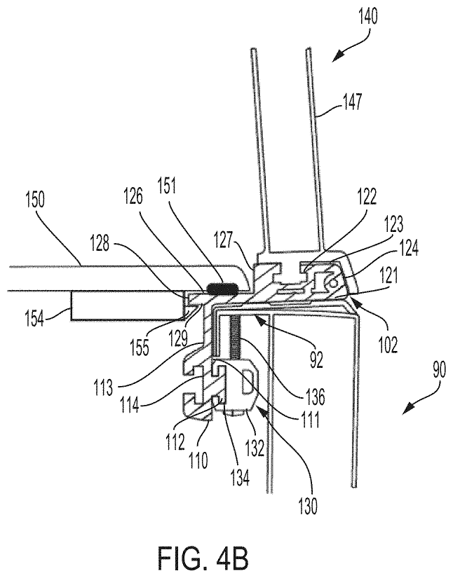

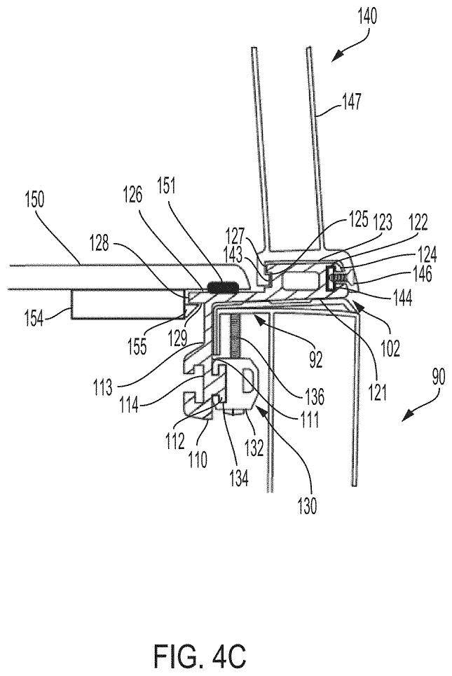

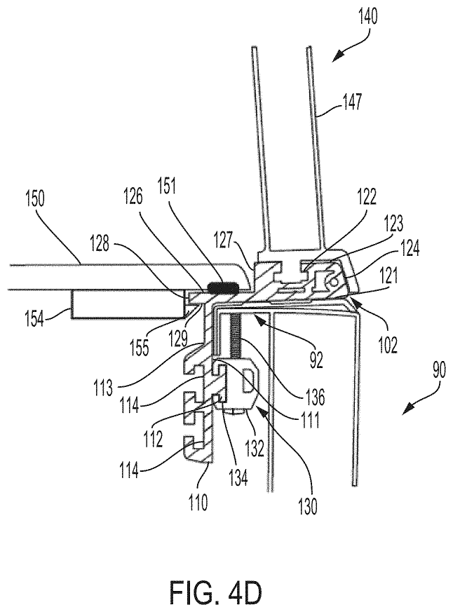

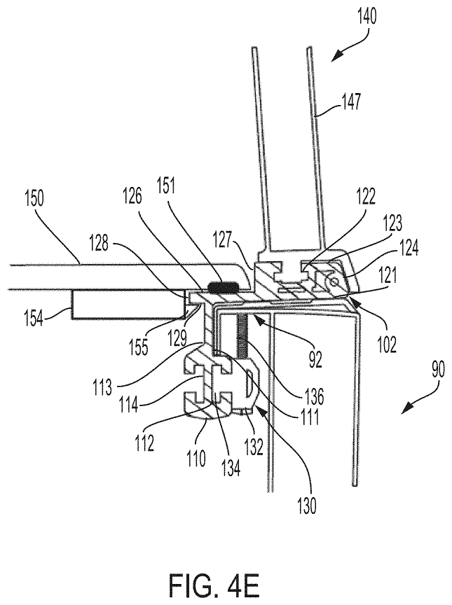

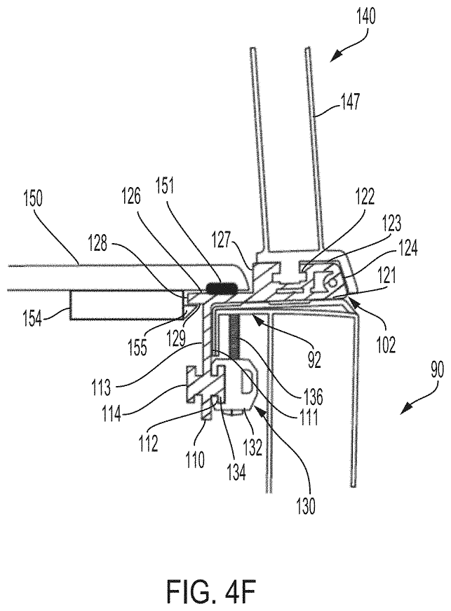

FIG. 3 is a partial cross-section view of rail 103 mounted on vehicle 90 taken along lines I-I of FIG. 1. Clamps 130 can be secured against sidewall 92, as shown in FIG. 3, to retain rail 102 to vehicle 90. FIGS. 4A-4F illustrate partial cross-section views of additional embodiments of rail 102 mounted on vehicle 90, taken along lines I-I of FIG. 1.

Rail 102 includes a lower extension 110 having a first side, a first lower side 111, and a second side, a second lower side 113, opposite first lower side 111 and extending along a length L2 and having a width W2 that extends generally vertically when rail 102 is mounted on a vehicle such as vehicle 90.

Rail 102 further includes an upper extension 120 extending from lower extension 110. Upper extension 120 has a first side, a first upper side 121, and a second side, a second upper side 123, opposite first upper side 121 and extending along a length L3 and having a width W3 that may extend generally horizontally when rail 102 is mounted on a vehicle such as vehicle 90. A third upper side 124 extends between first upper side 121 and second upper side 123, in an example, at approximately 45 degrees as shown in FIGS. 2, 3, and 4A-4F, or other suitable angle. A support surface 126, which may be generally flat, may extend across some or all of width W3 and some or all of length L3.

In some embodiments, L2 and L3 may be different lengths or dimensions, such as shown in FIG. 2. In other embodiments, L2 and L3 may be the same or generally the same lengths.

Rail 102 and components thereof can be formed from steel, aluminum (for example, a full length extruded aluminum rail), polymer, or other suitable material, or any suitable combination.

Conveniently, the material of rail 102 may cover the side areas and tops of your pickup bed walls of cargo bed 94 to protect cargo bed 94 from damage, such as from environmental elements or use when hauling objects resting within cargo bed 94.

In some embodiments, lower extension 110 of rail 102 includes a clamp track 112 and a lower accessory track 114.

Clamp track 112 may be located on lower extension 110 for receiving and retaining mounting clamps, such as a clamp 130, to secure rail 102 to cargo bed 94 or sidewalls 92 of vehicle 90.

In some embodiments, clamp track 112 is located on first lower side 111 of lower extension 110, opposite second lower side 113 on which lower accessory track 114 is located, as described in further detail below. Clamp track 112 may extend continuously or discontinuously along length L2 of lower extension 110, as shown in FIG. 2, or extend along one or more partial portions of length L2 of lower extension 110.

Clamp track 112 may define one or more recesses in lower extension 110 and/or include one or more protrusions from lower extension 110, or a combination thereof, along length L2 and extending from first lower side 111. In an example, clamp track 112 extends perpendicularly or generally perpendicularly from first lower side 111, or at another suitable angle. Clamp track 112 defines a profile shape in lower extension 110 formed by a cross-section cut along lines I-I.

As shown in FIGS. 3 and 4A-4F, a profile shape of clamp track 112 may be T-shaped. In some embodiments, a profile shape of clamp track 112 can approximate an I-beam, be pear-shaped, terminate with a flange, or other suitable profile shape to receive and retain clamps.

Clamp track 112 can be formed as a groove or a female receptacle (defining one or more recesses), as shown by of example in FIGS. 2, 3, 4A and 4E, to receive and retain a corresponding male connector component of a clamp 130 such as guide 134, and vice versa, with clamp track 112 formed as a rail or a male connector (including one or more protrusions), as shown by of example in FIGS. 4B, 4C, 4D and 4F, to fit inside a corresponding female receptacle component of a clamp 130 such as guide 134.

A profile shape defined by clamp track 112 in use with rail 102 mounted on vehicle 90 may be symmetric or asymmetric about a horizontal axis, and may be symmetric or asymmetric about a vertical axis.

FIG. 2 illustrates clamps 130 that can be used to secure rail 102 to vehicle 90, according to an embodiment. In use, one or more clamps 130 slide in clamp track 112, an can be is tightened against sidewall 92 to secure rail 102 to vehicle 90, as shown in FIG. 3.

Each clamp 130 may include a retaining block 132, a guide 134, and a movable arm 136.

In some embodiments, clamp 130 includes a retaining block 132 having a guide 134, shaped to be received in clamp track 112 and engage, in an example, slidably engage, with clamp track 112.

Guide 134 may be shaped complementary to clamp track 112 to slide into and be retained in clamp track 112. Guide 134 may define one or more recesses and/or include one or more protrusions, or a combination thereof.

Guide 134 may define a profile shape formed by a cross-section cut along lines I-I, show in FIG. 3, which may correspond to the profile shape of clamp track 112, as shown by way of example in FIG. 3.

As shown in FIGS. 3 and 4A-4F, a profile shape of guide 134 may be T-shaped. In some embodiments, a profile shape of guide 134 can approximate an I-beam, be pear-shaped, terminate with a flange, or other suitable profile shape to engage with clamp track 112.

Guide 134 can be formed as a groove or a female receptacle (defining one or more recesses), as shown by of example in FIGS. 4B, 4C, 4D, and 4F, to receive and hold a corresponding male connector component of clamp track 112, and vice versa, with guide 134 formed as a rail or a male connector (including one or more protrusions), as shown by of example in FIGS. 2, 3, 4A and 4E, to fit inside a corresponding female receptacle component of clamp track 112.

A profile shape of guide 134 in use with rail 102 mounted on vehicle 90 may be symmetric or asymmetric about a horizontal axis, and may be symmetric or asymmetric about a vertical axis.

Movable arm 136 of clamp 130 may be retained against retaining block 132, such as with a nut or head, and extends through retaining block 132 and is adjustable in length to contact sidewall 92.

In an example, movable arm 136 includes a rotary component such as a screw that terminates at a jaw or clamping plate for contacting sidewall 92. In use, the rotary component can be rotated to move the clamping plate linearly, such as to advance the clamping plate into contact with sidewall 92.

Other suitable clamping mechanisms, such as securing a clamp through sidewall 92, are also contemplated to secure rail 102 to vehicle 90.

In use, with rail 102 mounted to vehicle 90, first lower side 111 of rail 102 and clamp track 112 face a wall of cargo bed 94 and sidewall 92, and away from the interior of cargo bed 94, allowing rail 102 to be secured to vehicle 90 without obstructing the ability of accessories to be accessible and slide onto rail 102 to make use of cargo bed 94 space, as discussed in further detail below.

Embodiments of clamp 130 can be securable against sidewall 92 by extending movable arm 136 to establish a friction fit with sidewall 92. Clamp 130 thus applies a clamping force against sidewall 92 that is retained by a balancing force of upper extension 120 of rail 102, to secure rail 102 against vehicle 90.

Conveniently, rails such as rails 102 may be secured to a vehicle by way of clamps such as clamps 103 that are adjustable to various locations, in an example, at different attachment points along a continuous track such as clamp track 112, providing potentially infinite clamping positions. In use, clamp locations can be selected based on a configuration of the vehicle and its sidewalls and cargo bed, and the rails can thus accommodate differently shaped and configured vehicles. Clamps may also be conveniently disposed in a location that provides clearance for accessories to be mounted and utilized in a vehicle, and with relative ease, allowing for a storage area of a cargo bed to be fully utilized.

Lower extension 110 can also include a lower accessory track 114 to which accessories can be attached along length L1 of cargo bed 94, such as a storage box 160.

Lower accessory track 114 can receive accessories or attachment mechanisms such as connectors for accessories to secure accessories to rail 102, and thus to vehicle 90.

In some embodiments, lower accessory track 114 is located on second lower side 113 of lower extension 110, opposite first lower side 111 on which clamp track 112 is located. Lower accessory track 114 may extend continuously or discontinuously along length L2 of lower extension 110, as shown in FIG. 2, or extend along one or more partial portions of length L2 of lower extension 110 of rail 102.

Lower accessory track 114 may define one or more recesses in lower extension 110 and/or include one or more protrusions from lower extension 110, or a combination thereof, along length L2 and extending from second lower side 113. In an example, lower accessory track 114 extends perpendicularly or generally perpendicularly from second lower side 113, or at another suitable angle. Lower accessory track 114 defines a profile shape in lower extension 110 formed by a cross-section cut along lines I-I.

As shown in FIGS. 3 and 4A-4F, a profile shape of lower accessory track 114 may be T-shaped. In some embodiments, a profile shape of lower accessory track 114 can approximate an I-beam, be pear-shaped, terminate with a flange, or other suitable profile shape to receive and retain accessories.

Lower accessory track 114 can be formed as a groove or a female receptacle (defining one or more recesses), as shown by of example in FIGS. 4B, 4C, 4D and 4E, to receive and retain a corresponding male connector component of an accessory, and vice versa, with lower accessory track 114 formed as a rail or a male connector (including one or more protrusions), as shown by of example in FIGS. 2, 3, 4A and 4F, to fit inside a corresponding female receptacle connector component of an accessory.

A profile shape defined by lower accessory track 114 in use with rail 102 mounted on vehicle 90 may be symmetric or asymmetric about a horizontal axis, and may be symmetric or asymmetric about a vertical axis.

Lower extension 110 can also include multiple lower accessory tracks 114, in any combination of lower accessory track 114 configurations, disposed in any suitable location on lower extension 110, as shown for example in FIG. 4D, with an additional lower accessory track 114 disposed below a lower accessory track 114. As shown in FIG. 4D, one or more of lower accessory tracks 114 may be in horizontal alignment, in use on vehicle 90. Multiple lower accessory tracks 114 may allow for multiple accessories of different sizes, or with connectors at different locations, to be used with rail 102.

In use, with rail 102 mounted to vehicle 90, lower accessory track 114 may face inward to cargo bed 94, opposite to clamp track 112. Conveniently, lower accessory track 114 and associated accessories may not be obstructed by clamp track 112 or clamps 130.

Lower accessory track 114 can simultaneously receive one or more accessories, as described herein, such as storage box 160. Conveniently, lower accessory track 114 is configured to receive accessories to slide in and out of rail 102 with relative ease.

Rail 102 can also include an upper extension 120 that extends from lower extension 110 in an example, perpendicularly or generally perpendicularly from lower extension 110, or at another suitable angle, and having length L3 and width W3.

In use, first upper side 121 of upper extension 120 is supported by vehicle 90, and can contact and abut sidewall 92 of vehicle 90.

Support surface 126 of upper extension 120 may extend across some or all of width W3 and some or all of length L3, forming a generally horizontal mating surface that can support a tonneau cover 150 over cargo bed 94, installed on vehicle 90 in conjunction with rail 102.

In use, tonneau cover 150 or a seal 151 of tonneau cover 150 contacts support surface 126 as shown in FIGS. 4A-4F.

In some embodiments, support surface 126 is a depressed surface on second upper side 123, as shown in FIGS. 4A-4F, and a side rail surface 127 extends from the depressed surface.

In some embodiments, a side recess 125 defines one or more recesses in side rail surface 127 extending along some or all of length L3, as shown by way of example in FIG. 4C.

In some embodiments, upper extension 120 includes a lip 128 that protrudes over lower extension 110, allowing a tonneau cover such as tonneau cover 150 to be secured to rail 102 by way of lip 128, to attach the tonneau cover in place and can be secured to prevent theft.

Lip 128 can be of varying suitable thicknesses, and include a bottom surface 129, as shown in FIGS. 4A-4F.

In some embodiments, tonneau cover 150 may also include a spring clamp 154 including a spring biased latch 155 to abut bottom surface 129 of lip 128 and retain tonneau cover 150 against rail 102.

In some embodiments, upper extension 120 can also include an upper accessory track 122 to which accessories, such as rack 140, can be attached along length L1 above cargo bed 94.

Upper accessory track 122 can receive accessories or attachment mechanisms such as connectors for accessories to secure accessories to rail 102, and thus to vehicle 90.

In some embodiments, upper accessory track 122 is similar or the same in structure and/or shape to lower accessory track 114.

In some embodiments, upper accessory track 122 is located on second upper side 123 of upper extension 120, opposite first upper side 121 which abuts sidewall 92, as shown by way of example in FIGS. 2, 3, 4A, 4B and 4D-4F. In some embodiments, upper accessory track 122 is located on third upper side 124 of upper extension 120, as shown for example in FIG. 4C.

Upper accessory track 122 may extend continuously or discontinuously along length L3 of upper extension 120, as shown in FIG. 2, or extend along one or more partial portions of length L3 of upper extension 120 of rail 102.

Upper accessory track 122 may define one or more recesses in upper extension 120 and/or include one or more protrusions from upper extension 120, or a combination thereof, along length L3 and extend from second upper side 123 or third upper side 124. In an example, upper accessory track 122 extends perpendicularly or generally perpendicularly from second upper side 123 or third upper side 124, or at another suitable angle. Upper accessory track 122 defines a profile shape in upper extension 120 formed by a cross-section cut along lines I-I.

As shown in FIG. 3, a profile shape of upper accessory track 122 may be T-shaped. In some embodiments, a profile shape of upper accessory track 122 can approximate an I-beam, be pear-shaped, terminate with a flange, or other suitable profile shape to receive and retain accessories.

Upper accessory track 122 can be formed as a groove or a female receptacle (defining one or more recesses) to receive and retain a corresponding male connector component of an accessory, and vice versa, with upper accessory track 122 formed as a rail or a male connector (including one or more protrusions) to fit inside a corresponding female receptacle connector component of an accessory.

A profile shape defined by upper accessory track 122 in use with rail 102 mounted on vehicle 90 may be symmetric or asymmetric about a horizontal axis, and may be symmetric or asymmetric about a vertical axis.

In use, with rail 102 mounted to vehicle 90, upper accessory track 122 faces upwards from cargo bed 94 for receiving accessories above cargo bed 94.

Upper accessory track 122 can simultaneously receive one or more accessories, such as one or more of rack 140 or an alternate rack 140′ including a headache rack 141 that covers the passenger cab window, or other suitable rack, and other accessories such as those described herein that can slide in and be secured. FIG. 2 illustrates parts of rack 140, namely uprights 147 and connectors 142, for engagement with rail 102 and upper accessory track 122, in use.

Conveniently, upper accessory track 122 is configured to receive accessories to slide in and out of rail 102 with relative ease.

It should be understood that rail 102 may embody any and all combinations of components disclosed herein, including lower extension 110, clamp track 112, lower accessory track 114, upper extension 120, upper accessory track 122, side recess 125, supporting surface 126, and lip 128, and not limited to the combinations illustrated in the figures.

In use, two rails 102 can be mounted adjacent opposing sides of cargo bed 94, as shown in FIGS. 1 and 4. And receive one or more accessories in one or both rails 102.

Conveniently, with rails such as rail 102 installed in a vehicle, components or accessories can slide in and out of the rails with relative ease. In some embodiments, accessories can slidably engage with lower accessory track 114 and/or upper accessory track 122 along length L2 of lower extension 110 and/or length L3 of upper extension 120, allowing for a greater proportion of cargo bed 94, in particular, along length L1, can thus be exploited for storage and accessory use. In some embodiments, accessories can clip into a select position to engage with lower accessory track 114 and/or upper accessory track 122.

Accessories for use with system 100 include but are not limited to racks such as cargo racks or headache racks. Various racks such as racks 140 (and variations thereof including alternate rack 140′) can include mounts for cargo boxes, fuel cans (such as rotopax or Gerry), bicycles, canoes, lighting, roof top tents, or ladders.

Further accessories can include tonneau covers such as tonneau cover 150, containers or storage boxes such as storage box 160, dividers or containment walls to separate sections of cargo bed 94, lights, tie down connections, coolers, barbecues, and other such accessories.

Accessories can include or be attached to a connector, such as connector 142 shown in an exploded view with uprights 147 of rack 140 in FIG. 2, shaped to be received and retained in lower accessory track 114 and/or upper accessory track 122, and to engage, in an example, slidably engage, with lower accessory track 114 and/or upper accessory track 122.

A connector can be shaped complementary to lower accessory track 114 and/or upper accessory track 122 to slide into and be retained in lower accessory track 114 and/or upper accessory track 122. The connector may define one or more recesses and/or include one or more protrusions, or a combination thereof.

A connector may define a profile shape formed by a cross-section cut along lines I-I, show in FIG. 3, which may correspond to the profile shape of lower accessory track 114 and/or upper accessory track 122, as shown by way of example with connector 142 and upper accessory track 122 in FIG. 2.

In some embodiments, a connector such as connector 142 includes at a first end, a guide 144 shaped to be received in lower accessory track 114 or upper accessory track 122, and at a second end opposite the first end, a fastener 146, such as a nut and bolt or other suitable attachment mechanism, to secure to an accessory.

As shown in FIG. 2, a profile shape of guide 144 of connector 142 may be T-shaped. In some embodiments, a profile shape of a connector such as connector 142 can approximate an I-beam, be pear-shaped, terminate with a flange, or other suitable profile shape.

A connector can be formed as a groove or a female receptacle to receive and hold a corresponding male connector component of lower accessory track 114 and/or upper accessory track 122, and vice versa, with the connector formed as a rail or a male connector to fit inside a corresponding female receptacle component of lower accessory track 114 and/or upper accessory track 122.

A profile shape of a connector in use with rail 102 mounted on vehicle 90 may be symmetric or asymmetric about a horizontal axis, and may be symmetric or asymmetric about a vertical axis.

One or more connectors of an accessory can be received in the same rail 102 or corresponding rails 102 on each side of a cargo bed 94.

Accessories can be locked in place in a particular position along rail 102, such as in lower accessory track 114 or upper accessory track 122, with a set screw, a cam lock, a suitable locking mechanism or combination thereof.

An example of accessories suitable for use with embodiments of system 100 include a rack or vertical rack upright such as rack 140, as illustrated for example in FIG. 1, having uprights 147 and a load bar or crossbar 148 between two uprights 147, each upright 147 attached to crossbar 148 by way of brackets 149.

Rack 140 can be movable along length L3 of upper extension 120 of rail 102, in the directions of arrows A as shown in FIG. 1. Rack 140 can be extensible along width W1 of cargo bed 94, for example, brackets 149 moving along crossbar 148 in the directions of arrows B as shown in FIG. 1. Rack 140 can be adjustable in height, for example, brackets 149 moving along uprights 147 in the directions of arrows C as shown in FIG. 1, which can provide, in an example, six inches of user positionable vertical adjustment.

Rack 140 can be formed from steel, aluminum (for example, extruded aluminum rail and/or welded aluminum construction), or other suitable material.

In some embodiments, rack 140 is attachable to rail 102 by way of one or more connectors 142 having a guide 144 receivable in upper accessory track 122 and a fastener 146 attachable to a component of rack 140, such as an upright 147.

In some embodiments, rack 140 includes a hook protrusion 143 that can extend in an L-shape from upright 147 to engage with side recess 125, which may provide additional support for rack 140 to retain rack 140 against rail 102.

A rack such as rack 140 or alternate rack 140′ can include suitable components such as mounting points, in an example on bracket 149, such as fuel can mounts (rotopax or Gerry), bicycle mounts, canoe mounts, lighting mounts, roof top tent mounts, ladder mounts, or add-ons such as a headache rack or cargo boxes.

In use, multiple racks such as a pair of front and rear racks 140 can be used together, such as in the configuration shown in FIG. 1, optionally, with one or more connecting side bars (not shown) connecting a front rack 140 and a rear rack 140.

Another accessory for use with system 100 includes a tonneau cover such as tonneau cover 150, which may be secured to rail 102 by engaging, for example, by way of a latch or hook and loop mechanism, with lip 128, which may secure tonneau cover 150 in place and prevent theft.

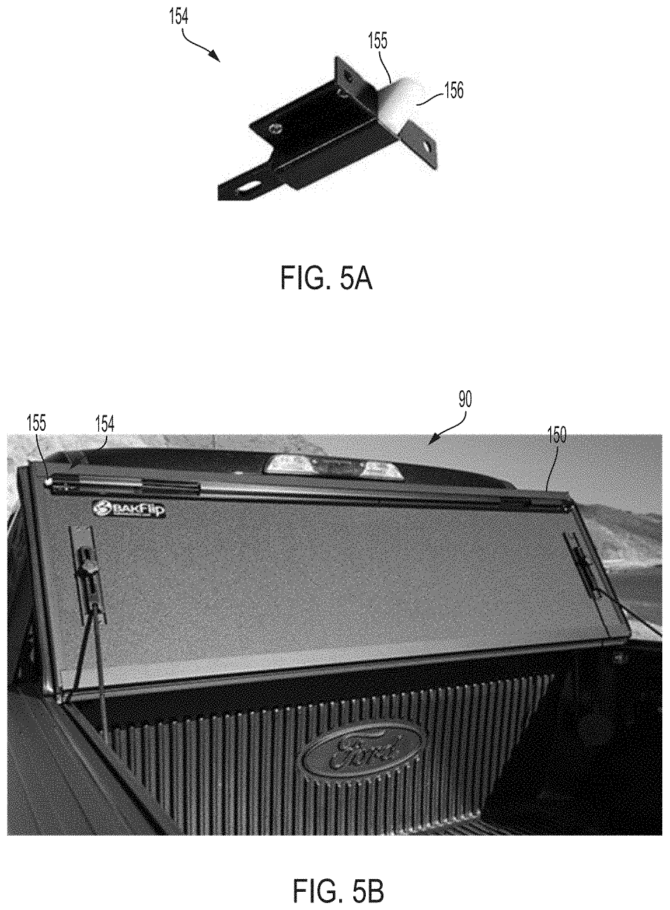

In some embodiments, tonneau cover 150 may also include one or more spring clamps 154, shown by way of example in FIG. 5A, and installed on a tonneau cover 150 on vehicle 90 in FIG. 5B.

Spring clamp 154 includes latch 155, biased (for example, with a spring) to extend latch 155 to the position shown in FIGS. 5A and 5B. In use, as tonneau cover 150 is lowered onto rail 102, an angled surface 156 of latch can engage with lip 128 to retract latch 155. Once clear of lip 128, latch 155 can snap back to the extended position shown in FIGS. 4A-4F to retain tonneau cover 150 against rail 102.

In an extended position in use, latch 155 can be disposed below lip 128 and may contact bottom surface 129 to retain tonneau cover 150 against rail 102.

In an example, tonneau cover 150 can be a four-panel, ridged folding cover, having panels 152A, 152B, 152C, 152D as shown in FIG. 1.

Panels 152A, 152B, 152C, 152D can be articulating, and disposed at a front of vehicle 90 (adjacent a cab of vehicle 90) and at a rear of vehicle 90 (adjacent a tailgate of vehicle 90). By way of example, panel 152A is shown in an open position, opened in the direction of arrow D as shown in FIG. 1. In some embodiments, tonneau cover 150 includes a latching mechanism at each panel or folding segment.

In some embodiments, tonneau cover 150 includes a seal 151 extending along the length of tonneau cover 150, for example, generally parallel to L1 in use, for contact with supporting surface. Seal 151 may be formed of a polymer, rubber, or other suitable material, and as part of tonneau cover 150 to seal the interior of cargo bed 94, for example, from environmental conditions such as rain, snow and dirt.

Tonneau cover 150 may be lockable from front and rear access, for example, by way of a rotary lock.

In some embodiments, tonneau cover 150 can include a quick detach feature to remove the entire tonneau cover 150 from vehicle 90, for example, by disengaging one or more spring clamps 154.

In some embodiments, tonneau cover 150 includes a reversible pivot at a front panel such as panel 152A, such that the front panel can flip back and fold on itself.

Another accessory for use with system 100 includes a storage box, such as storage box 160.

Storage box 160 can include a storage area 162 and optionally, a cover 164, as shown in FIG. 1. Cover 164 may be rotatable to open in the direction of arrow E as shown in FIG. 1. In some embodiments, cover 164 is lockable, in particular, when embodied without a tonneau cover.

Accessories such as a storage box 160, shown in FIG. 1, can be disposed below tonneau cover 150, with tonneau cover 150 abutting supporting surface 126 of upper extension 120 of rail 102. Storage box 160 can be received in lower accessory track 114 on rail 102 mounted to each side of vehicle 90, and is positionable on lower accessory tracks 114 along length L2.

A storage box 160 can be accessible and lockable through an articulating tonneau cover panel such as tonneau cover 150.

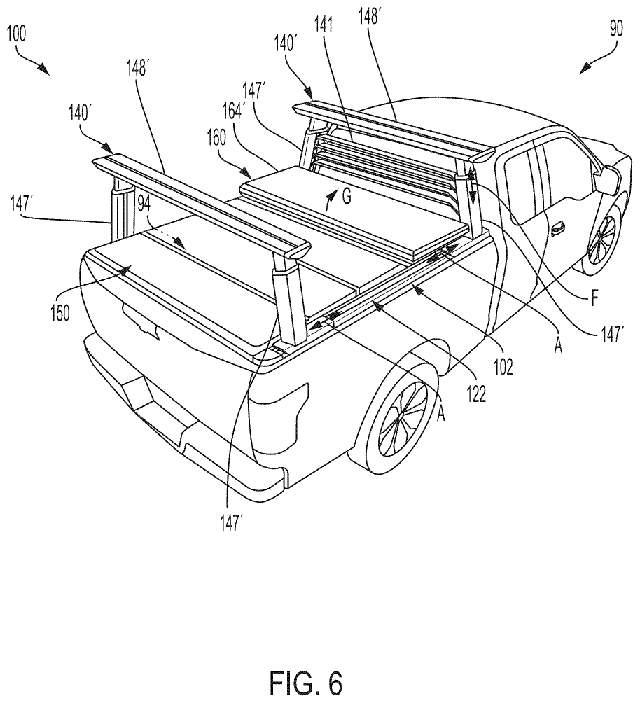

In some embodiments, as shown in FIG. 6, storage box 160 can be disposed above a tonneau cover or without a tonneau cover, with a cover 164′ that opens in the direction of arrow G, and connectors are in suitable position on storage box 160 to engage with lower accessory track 114.

Storage box 160 optionally may include interior storage and organization components and configurations.

FIG. 6 illustrates an embodiment of a cargo bed system 100 with an alternate rack 140′ in place of rack 140. Alternate rack 140′ can be configured with a headache rack 141 to cover a passenger cab window of vehicle 90, as shown.

Alternate rack 140′ can be similar in structure and components to rack 140, having alternate uprights 147′ and a load bar or crossbar 148′ between two uprights 147′, and similarly movable along length L3 of upper extension 120 of rail 102, in the directions of arrows A as shown in FIG. 6.

Alternate rack 140′ can be adjustable in height, for example, crossbar 148′ moving along uprights 147 in the directions of arrows F as shown in FIG. 6, which can provide, in an example, six inches of user positionable vertical adjustment.

Alternate rack 140′ can be formed from steel, aluminum (for example, extruded aluminum rail and/or welded aluminum construction), or other suitable material.

In some embodiments, alternate rack 140′ is attachable to rail 102 by way of one or more connectors, such as connectors 142, having guide 144 receivable in upper accessory track 122 and fastener 146 attachable to a component of alternate rack 140′, such as an upright 147′.

Alternate rack 140′ can include suitable components such as mounting points, including ladder retainers, or headache rack 141 as shown.

In use, multiple alternate racks 140′ such as a pair of front and rear alternate racks 140′ can be used together, such as in the configuration shown in FIG. 6, optionally, with one or more connecting side bars (not shown) connecting a front alternate rack 140′ and a rear alternate rack 140′.

Other suitable kinds of racks can be used with rail 102 and/or as part of a cargo bed system 100.

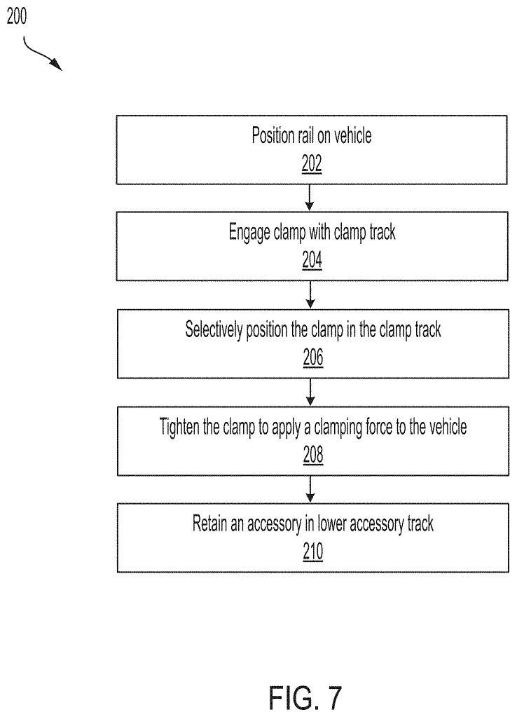

FIG. 7 illustrates a flow chart of a method 200 for installing a cargo bed system, such as system 100, or components therein, according to an embodiment. The steps are provided for illustrative purposes. Variations of the steps, omission or substitution of various steps, or additional steps may be considered.

At block 202, a rail such as rail 102 is positioned on a vehicle such as vehicle 90, for vehicle 90 to support upper extension 120 of rail 102.

At block 204, a clamp such as clamp 130 is engaged with clamp track 112, clamp track 112 located on first side 111 of lower extension 110 of rail 102, as disclosed herein.

At block 206, clamp 130 is selectively positioned in clamp track 112 along length L2 of lower extension 110.

At block 208, clamp 130 is tightened to apply a clamping force to vehicle 90 to retain rail 102 against vehicle 90.

In some embodiments, tightening clamp 130 comprises rotating clamp 130 to extend movable arm 136 of clamp 130 to contact vehicle 90.

At block 210, an accessory such as storage box 160 is retained in lower accessory track 114 on second side 113 of lower extension 110.

In some embodiments, retaining the accessory comprises engaging or slidably engaging the accessory with lower accessory track 114.

In some embodiments, method 200 further includes retaining an additional accessory in upper accessory track 122 of upper extension 120.

In some embodiments, method 200 further includes positioning a tonneau cover such as tonneau cover 150 to contact supporting surface 126 of upper extension 120.

It should be understood that one or more of the blocks may be performed in a different sequence or in an interleaved or iterative manner.

Conveniently, systems such as cargo bed system 100, rails such as rail 102, and methods such as method 200 as disclosed herein may provide multiple configurations for attaching multiple accessories to a vehicle, and furthermore may allow for a user to quickly and easily attach and remove accessories when desired.

In an example, for day-to-day use, a user may find it useful to have a tonneau cover and storage box installed in a vehicle. It may be desirable, in certain cases, to remove components such as the tonneau cover and the storage box to allow large furniture to be moved in the vehicle. In another example, a user may occasionally wish to install rack components for carrying a ladder or sports equipment. In these examples, traditional mounting racks are unwieldly and can make it difficult and inconvenient for accessories to be attached and removed.

Conveniently, with rails such as rail 102 installed in a vehicle, components or accessories can slide in and out of the rails with relative ease. Configurations of tracks on rails such as rail 102 can allow for accessories to attach both below a tonneau cover, such as with lower accessory track 114, as well as above a tonneau cover, as well as above a cargo bed, such as with upper accessory track 122, and to be in use concurrently.

Furthermore, rails may be secured to the vehicle by way of clamps such as clamps 103 that are adjustable to various locations, in an example, along a continuous track such as clamp track 112, providing potentially infinite clamping positions. In use, clamp locations can be selected based on a configuration of the vehicle and its sidewalls and cargo bed, and the rails can thus accommodate differently shaped and configured vehicles. Clamps may also be conveniently disposed in a location that provides clearance for accessories to be mounted and utilized in a vehicle, and with relative ease, allowing for a cargo area to be fully utilized.

Of course, the above described embodiments are intended to be illustrative only and in no way limiting. The described embodiments are susceptible to many modifications of form, arrangement of parts, details and order of operation. The disclosure is intended to encompass all such modification within its scope, as defined by the claims.

What is claimed is:

1. A rail for mounting to a vehicle having a cargo bed, the rail comprising:
a lower extension having a first side and a second side, opposite the first side, extending along a length;
an upper extension extending generally perpendicularly from the length of the lower extension, supportable by the vehicle;
a clamp track located on the first side of the lower extension and extending along the length of the lower extension for receiving one or more clamps to secure the rail to the vehicle; and
a lower accessory track located on the second side of the lower extension and extending along the length of the lower extension for receiving an accessory within the cargo bed.

2. The rail of claim 1, wherein the one or more clamps are shaped to slidably engage with the clamp track.

3. The rail of claim 1, wherein the clamp track defines a recess within the lower extension.

4. The rail of claim 1, wherein the clamp track includes a protrusion from the lower extension.

5. The rail of claim 1, wherein the clamp track is continuous along the length of the lower extension.

6. The rail of claim 1, wherein the accessory is shaped to slidably engage with the lower accessory track.

7. The rail of claim 1, wherein the lower accessory track defines a recess within the lower extension.

8. The rail of claim 1, wherein the lower accessory track includes a protrusion from the lower extension.

9. The rail of claim 1, wherein the lower accessory track is continuous along the length of the lower extension.

10. The rail of claim 1, wherein the upper extension includes an upper accessory track extending along a length of the upper extension for receiving an additional accessory above the cargo bed.

11. The rail of claim 10, wherein the upper accessory is shaped to slidably engage with the upper accessory track.

12. The rail of claim 10, wherein the upper accessory track defines a recess within the upper extension.

13. The rail of claim 10, wherein the upper accessory track includes a protrusion from the upper extension.

14. The rail of claim 1, wherein the upper extension has a first side adjacent the vehicle and a second side, opposite the first side of the upper extension, the second side of the upper extension including a generally flat surface to support a tonneau cover.

15. The rail of claim 1, further comprising an additional lower accessory track located on the second side of the lower extension and extending along the length of the lower extension for receiving an accessory within the cargo bed.

16. A system for use with a cargo bed of a vehicle, comprising:
a plurality of clamps; and
two rails mountable to the vehicle, adjacent opposing sides of the cargo bed, each rail of the two rails including:
a lower extension having a first side and a second side, opposite the first side, extending along a length;
an upper extension extending generally perpendicularly from the length of the lower extension, supportable by the vehicle;
a clamp track located on the first side of the lower extension and extending along the length of the lower extension for receiving one or more of the plurality of clamps; and
a lower accessory track located on the second side of the lower extension and extending along the length of the lower extension for receiving an accessory within the cargo bed,
wherein the plurality of clamps are shaped to engage with the clamp track of each rail to secure that rail to the vehicle.

17. The system of claim 16, wherein the plurality of clamps are shaped to slidably engage with the clamp track of each rail.

18. The system of claim 16, wherein the plurality of clamps are configured to apply a clamping force to the vehicle retained by a balancing force of the upper extension.

19. The system of claim 16, wherein each of the plurality of clamps includes a guide to engage with the clamp track and a movable arm adjustable in length to contact the vehicle.

20. The system of claim 16, wherein the accessory is shaped to slidably engage with the lower accessory tracks of the two rails.

21. The system of claim 16, wherein the accessory is a storage box.

22. The system of claim 16, wherein the upper extension of each rail includes an upper accessory track extending along a length of the upper extension for receiving an additional accessory above the cargo bed.

23. The system of claim 22, wherein the additional accessory is shaped to slidably engage with the upper accessory tracks of the two rails.

24. The system of claim 22, wherein the additional accessory is a rack.

25. The system of claim 16, wherein the upper extension of each rail has a first side adjacent the vehicle and a second side, opposite the first side of the upper extension, the second side of the upper extension including a generally flat surface to support a tonneau cover.

26. A method for installing a cargo bed system including a clamp and a rail on a vehicle, the rail including a lower extension having a first side and a second side, opposite the first side, extending along a length, and the rail further including an upper extension extending generally perpendicularly from the length of the lower extension, the method comprising:
positioning the rail on the vehicle for the vehicle to support the upper extension;
engaging the clamp with a clamp track on the first side of the lower extension;
selectively positioning the clamp in the clamp track along the length of the lower extension;
tightening the clamp to apply a clamping force to the vehicle to retain the rail against the vehicle; and
retaining an accessory in a lower accessory track on the second side of the lower extension.

27. The method of claim 26, wherein the engaging the clamp with the clamp track comprises slidably engaging the clamp with the clamp track.

28. The method of claim 26, wherein the tightening the clamp comprises rotating the clamp to extend a movable arm of the clamp to contact the vehicle.

29. The method of claim 26, wherein the retaining the accessory comprises slidably engaging the accessory with the lower accessory track.

30. The method of claim 26, further comprising retaining an additional accessory in an upper accessory track of the upper extension, the upper accessory track extending along a length of the upper extension.

31. The method of claim 26, further comprising positioning a tonneau cover to contact a generally flat surface of the upper extension, the generally flat surface opposite a side of the upper extension adjacent the vehicle.
